(19) United States
(12) Patent Application Publication
(10) Pub. No.: US 2013/0122481 A1
(43) Pub. Date: May 16, 2013

(54) System and Devices for Providing Real-Time Feedback on Student Test Performance and Test Quality

(71) Applicant: Alan Neil ROVNER, Vancouver, WA (US)

(72) Inventor: Alan Neil ROVNER, Vancouver, WA (US)

(21) Appl. No.: 13/296,726

(22) Filed: Nov. 15, 2011

(51) Int. Cl. G09B 5/00

(52) U.S. Cl. 434/350

(57) ABSTRACT

System and devices for providing real-time feedback on student test performance and test quality of a test being administered. The methods and devices operate in a classroom network having a plurality of student devices configured to receive answers to test questions entered on the student devices and transmit in real-time the answers, and a teacher console communicatively coupled to the student devices and configured, for each answer, to receive in real-time the answer, update in real-time, using the answer, a test-taking metric and display in real-time an updated test-taking chart generated using the updated test-taking metric.

### BACKGROUND OF THE INVENTION

The present invention relates to educational assessment and, more particularly, real-time assessment of student performance on a test and the quality of the test.

The testing paradigm in use in most schools offers little or no feedback to the teacher about student performance on a test or the quality of the test while the test is being administered. Typically, the teacher hands each student a paper copy of the test and returns to his or her desk. When the test period is over, the teacher collects the papers and manually grades them (or sends them through a grading machine, in the case of certain multiple choice exams). During the test, the teacher has little or no visibility into how students are performing on the test on an individual or collective basis, such as the number of correct and incorrect answers given by each student and the entire class. The teacher also has little or no visibility into the quality of the test questions, such as which questions the students are answering right and wrong most frequently and which questions the students are spending the most and least time answering.

It is known to distribute networked computing devices to students for the purpose of audience participation in a classroom lecture. These networked computing devices allow students to register their answers to questions posed during the lecture to a server that aggregates and displays classroom wide results. However, these systems do not yield real-time feedback on student test performance or test quality.

### SUMMARY OF THE INVENTION

The present invention addresses a system and devices that provide real-time feedback about student performance on a test and the quality of the test.

In one aspect of the invention, a teacher console for providing real-time feedback about a test being administered on a plurality of student devices comprises a network interface, a user interface and a processor communicatively coupled with the network interface and the user interface, wherein for each of a plurality of answers to test questions entered on the student devices the teacher console receives in real-time the answer via the network interface, under control of the processor updates in real-time, using the answer, a test-taking metric and displays in real-time on the user interface an updated test-taking chart generated using the updated test-taking metric.

In some embodiments, the teacher console under control of the processor outputs in real-time on the user interface an alarm based at least in part on the updated test-taking metric.

In some embodiments, the alarm is triggered based at least in part on conformance between the updated test-taking metric and an alarm condition entered on the user interface.

In some embodiments, the teacher console transmits the test to each of the student devices via the network interface.

In some embodiments, the teacher console transmits a web link to the test to each of the student devices via the network interface.

In some embodiments, the teacher console transmits a test mode entry request to each of the student devices via the network interface and receives a test mode entry acknowledgement from each of the student devices via the network interface.

In some embodiments, the updated test-taking chart displays a count of answers to a test question on a classroom wide basis.

In some embodiments, the updated test-taking chart displays counts of answers for each of multiple choices for a test question on a classroom wide basis.

In some embodiments, the updated test-taking chart displays counts of correct and incorrect answers to a test question on a classroom wide basis.

In some embodiments, the updated test-taking chart displays an answer rate for a test question on a classroom wide basis.

In some embodiments, the updated test-taking chart displays counts of correct and incorrect answers on a per student basis.

In some embodiments, the updated test-taking chart displays an answer rate on a per student basis.

In some embodiments, the updated test-taking chart displays a test score on a per student basis.

In some embodiments, the updated test-taking chart is a bar chart.

In some embodiments, the updated test-taking chart is a pie chart.

In another aspect of the invention, a student device for providing real-time answers for a test being administered by a teacher console comprises a network interface, a user interface and a processor communicatively coupled with the network interface and the user interface, wherein for each of a plurality of answers to test questions entered on the user interface the student device under control of the processor transmits in real-time the answer to the teacher console via the network interface whereupon the teacher console updates in real-time, using the answer, a test-taking metric and displays in real-time on the teacher console an updated test-taking chart generated using the updated test-taking metric.

In yet another aspect of the invention, a communication system for providing real-time feedback about a test being administered comprises a plurality of student devices configured to receive answers to test questions inputted on the student devices and transmit in real-time the answers, and a teacher console communicatively coupled with the student devices and configured, for each answer, to receive in real-time the answer, update in real-time, using the answer, a test-taking metric and display in real-time an updated test-taking chart generated using the updated test-taking metric.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in some embodiments of the invention.

FIG. 2 shows a classroom computing device in some embodiments of the invention.

FIG. 3 shows a method performed by a teacher console for providing real-time feedback about a test being administered on a plurality of student devices in some embodiments of the invention.

FIG. 4 shows a method performed by a student device for providing real-time answers on a test being administered by a teacher console in some embodiments of the invention.

FIG. 5 is a first bar chart showing real-time counts of answers for each of multiple choices for each test question on a classroom wide basis.

FIG. 6 is a second bar chart showing real-time counts of answers for each of multiple choices for each test question on a classroom wide basis.

FIG. 7 is a pie chart showing real-time counts of answers for each of multiple choices for a particular test question on a classroom wide basis.

FIG. 8 is a pie chart showing real-time answer rates on a per student basis.

FIG. 9 is a pie chart showing real-time counts of correct and incorrect answers to a particular test question on a classroom wide basis.

FIG. 10 is a bar chart showing real-time counts of correct and incorrect answers to each test question on a classroom wide basis.

### DETAILED DESCRIPTION OF A PREFERRED EMBODIMENT

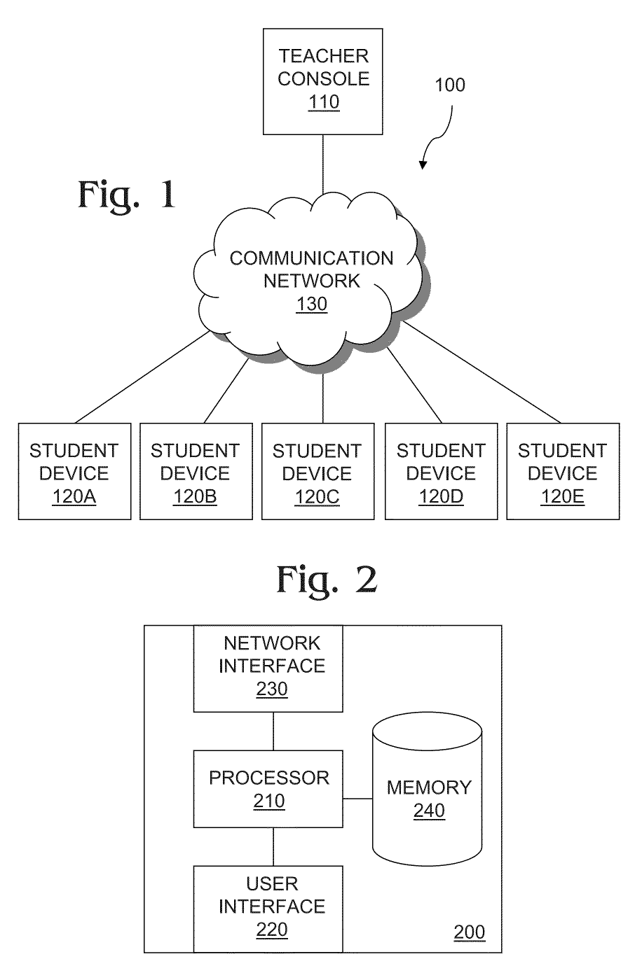

FIG. 1 shows a communication system 100 configured to provide real-time feedback about a test being administered in some embodiments of the invention. Communication system 100 includes a multiple of student devices 120A-120E communicatively coupled with a teacher console 110 over a communication network 130. Communication network 130 may be a wired network, such as an IEEE 802.3 (Ethernet) network, a wireless network, such as an IEEE 802.11 (WiFi) network, or a hybrid wired/wireless network. The teacher of the class operates teacher console 110 and each student in the class operates one of student devices 120A-120E. While five student devices 120A-120E are shown, this number is purely exemplary and will vary with class size. Moreover, in some embodiments, the classroom may be wholly or partly a virtual classroom in which some or all of student devices 120A-120E are remotely connected to teacher console 110 over a wide area network.

FIG. 2 shows a classroom computing device 200 in some embodiments of the invention. Both teacher console 110 and student devices 120A-120E have the elements of classroom computing device 200. Device 200 has a user interface 220, a network interface 230 and a memory 240, all of which are communicatively coupled with a processor 210. User interface 220 includes input devices, such as a touch screen, keyboard, keypad, computer mouse and/or microphone, and output devices, including a video display and speaker. User interface 220 allows the user of device 200 (i.e., a teacher or student) to submit input data and receive output data. Network interface 230 is a wired or wireless network interface, such as an Ethernet or WiFi interface. Network interface 230 allows device 200 to exchange data with other devices in communication system 100. Memory 240 includes random access memory and a read-only memory elements. Device 200 performs processing functions by executing under the control of processor 210 software program instructions stored in memory 240.

Accordingly, teacher console 110 may be a desktop, notebook or tablet computer that receives inputs described herein from a teacher via a user interface, displays output described herein to the teacher via the user interface, exchanges data with student devices 120A-120E via a network interface and performs processing functions described herein by executing teacher utility software instructions on a processor.

Similarly, each of student devices 120A-120E may be a custom handheld student tutoring device, notebook computer, tablet computer, smart phone or personal data assistant that receives inputs described herein from a student via a user interface, displays output described herein to the student via the user interface, exchanges data with teacher console 110 via a network interface and performs processing functions described herein by executing student tutoring software instructions on a processor.

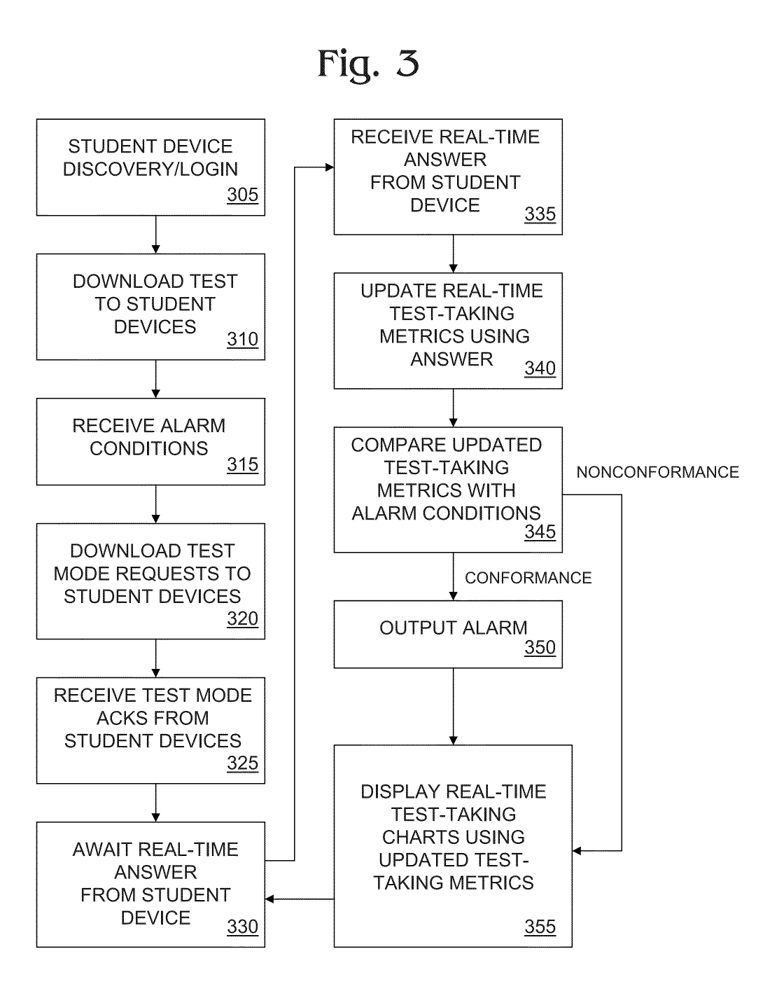

FIG. 3 shows a method performed by teacher console 110 for providing real-time feedback about a test being administered on student devices 120A-120E in some embodiments of the invention. At the outset, teacher console 110 discovers student devices 120A-120E (305). Web Services Dynamic Discovery (WS-Discovery) may be invoked for this purpose, with student devices 120A-120E in the server role and teacher console 110 in the client role. WS-Discovery allows teacher console 110 to acquire and maintain a current list of student devices 120A-120E. Student devices 120A-120E join the same network and subnet as teacher console 110. As an alternative to WS-Discovery, students using student devices 120A-120E manually log in to teacher console 110 using configured usernames and passwords.

Next, teacher console 110 downloads a test to student devices 120A-120E (310). The test may be a multiple choice test, a fill-in-the-blank test, an essay test, or some combination. An application programming interface on student devices 120A-120E may be invoked by teacher console 110 allowing teacher console 110 to download the test content (e.g., test instructions, test questions, choices, etc.) to student devices 120A-120E. Alternatively, teacher console 110 may download a web link to student devices 120A-120E allowing student devices 120A-120E to retrieve the test content from a remote web server using a standard web browser.

Next, teacher console 110 receives alarm conditions entered by the teacher (315). Alarm conditions include student test performance and test quality thresholds that are compared in real-time for conformance with per test question or per student test-taking metrics as the test is being administered. An alarm is outputted in response to a finding of conformance. The alarm may be visual, auditory or tactile. For example, the teacher may instruct that a visual alarm be outputted identifying any student whose real-time test score is below a certain threshold, or who has taken longer than a certain amount of time to answer a question, or who has not answered a certain number of questions in a certain number of minutes.

In addition to alarm conditions, the teacher may configure filters through inputs on teacher console 110. For example, the teacher may configure a grade color-coding filter such that any student's real-time test score that is below a first threshold percentage is displayed in yellow and below a second, lower threshold percentage is displayed in red. Moreover, for a test that has fill-in-the-blank or essay questions, the teacher may configure text-based filters to flag misspelled words, grammar errors and the like.

Next, teacher console 110 downloads requests to student devices 120A-120E to enter a test mode (320). A Representational State Transfer (REST) protocol may be invoked for this purpose, whereby teacher console 110 issues test mode requests in the form http://IP?setTestMode=1. While in the test mode, student devices 120A-120E upload in real-time to teacher console 110 answers inputted by students to questions on the test received from teacher console 110. In addition, while in test mode, applications on student devices 120A-120E are limited to those needed for a specific test. For example, for a chemistry test, a periodic table application may be enabled, while a financial calculator would be disabled for such a test.

Next, teacher console 110 receives acknowledgements from student devices 120A-120E acknowledging that student devices 120A-120E have entered the test mode (325). The REST protocol may again be invoked.

At this point, teacher console 110 may receive personal or background information from student devices 120A-120E, such as the names of the students operating student devices 120A-120E. Teacher console 110 then receives a test start indication entered by the teacher and enters a listening state where teacher console 110 awaits a first real-time answer to a test question from one of student devices 120A-120E (330). The REST protocol may again be invoked to upload the answer.

Next, teacher console 110 receives a real-time answer to a test question from one of student devices 120A-120E (335). For example, where the test is a multiple choice test, the answer may include a question number (e.g., Question=“1”) and a multiple choice selection (e.g., Answer=“C”). The answer may also identify the student who gave the answer (e.g., “John”). Alternatively, the identity of the student giving the answer may be inferred from a source address [e.g., Internet Protocol (IP) or Media Access Control (MAC) address] in a data packet containing the answer.

Next, teacher console 110 updates in real-time test-taking metrics based on the answer (340). For example, teacher console 110 may update a count of answers to the test question received from the class, a count of answers making the same multiple choice selection received from the class, a count of correct or incorrect answers to the test question received from the class, an answer rate for the test question for the class, a count of correct or incorrect answers received from the student, an answer rate for the student and/or a test score (i.e., percent of correct answers) for the student. Naturally, additional or different test-taking metrics may be monitored and updated.

Next, teacher console 110 compares the updated test-taking metrics with applicable alarm conditions to determine whether there is conformance with any alarm condition (345). For example, if an alarm condition specifies that a visual alarm be triggered identifying any student whose real-time test score is below a certain threshold, and the answer causes the student's test score to fall below the threshold, conformance is detected and a visual alarm is triggered.

It bears noting that conformance with certain alarm conditions may also arise if too much time elapses without receiving an answer. For example, an alarm condition may specify that a visual alarm be triggered identifying any student who has taken longer than a certain amount of time to answer a question or who has not answered a certain number of questions in a certain number of minutes. Teacher console 110 continually compares test-taking metrics for conformance with such alarm conditions without regard to whether any test-taking metric has been updated.

If conformance is detected, teacher console 110 outputs the alarm indicated for the alarm condition with which conformance has been found (350) and the flow proceeds to Step 355. On the other hand, if conformance is not detected, the flow proceeds to Step 355 without outputting an alarm.

Finally, teacher console 110 displays in real-time one or more test-taking charts based on the updated test-taking metrics (355). For example, teacher console 110 may display a chart showing a count of answers to the test question or all test questions received from the class as a whole, a chart showing a count of answers for each multiple choice selection for the test question or all test questions received from the class as a whole, a count of correct and incorrect answers to the test question or all test questions received from the class as a whole, an answer rate for the test question or all test questions for the class as a whole, a count of correct and incorrect answers received from the student or all students, an answer rate for the student or all students and/or a test score (i.e., percent of correct answers) for the student or all students. Naturally, additional or different test-taking charts may be displayed. Test-taking charts may be presented in the form of bar charts or pie charts, by way of example.

At that point, teacher console 110 reenters the listening state where teacher console 110 awaits the next real-time answer from one of student devices 120A-120E (330).

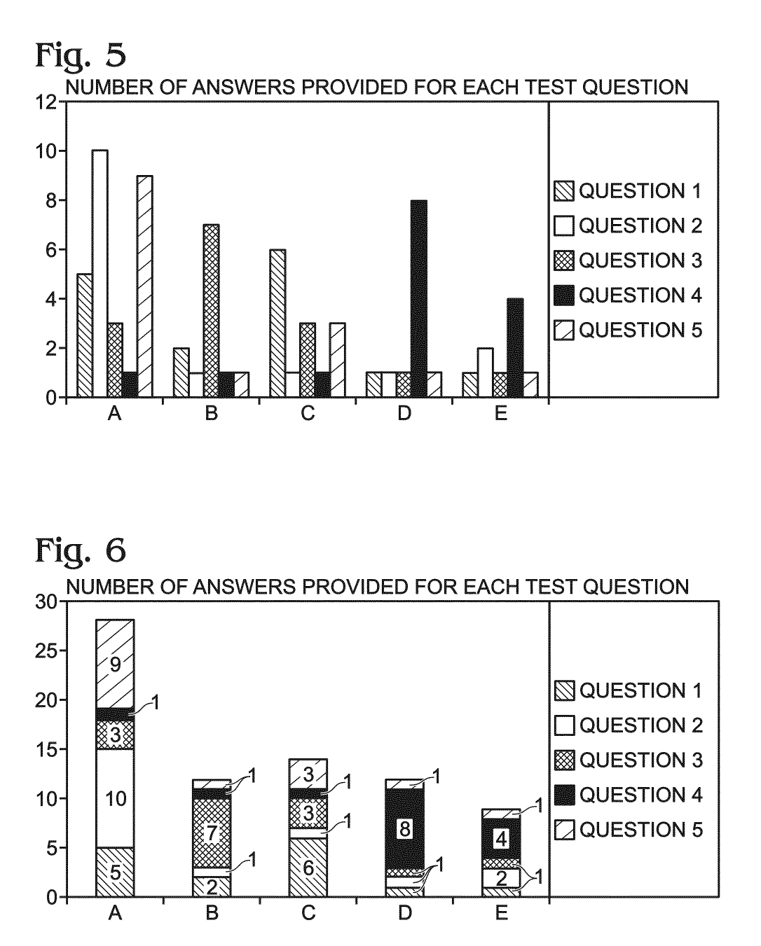

FIGS. 5-10 show exemplary real-time test-taking charts that may be displayed on teacher console 110. While the charted items are distinguished in these figures by different hatch patterns, in some embodiments the charted items may be distinguished by other means, such as different colors.

FIG. 5 is a first bar chart showing real-time counts of answers for each of multiple choices “A” through “E” for each test question “1” through “5” on a classroom wide basis.

FIG. 6 is a second bar chart showing real-time counts of answers for each of multiple choices “A” through “E” for each test question “1” through “5” on a classroom wide basis.

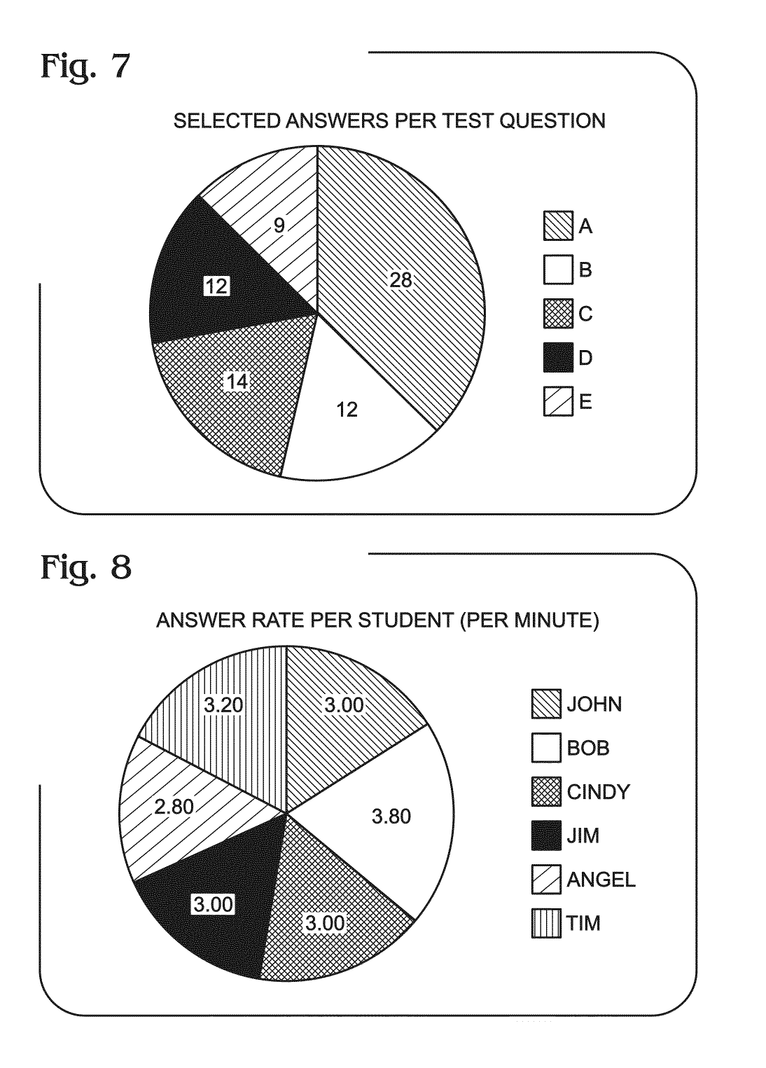

FIG. 7 is a pie chart showing counts of answers for each of multiple choices “A” through “E” for a particular test question on a classroom wide basis.

FIG. 8 is a pie chart showing answer rates on a per student basis.

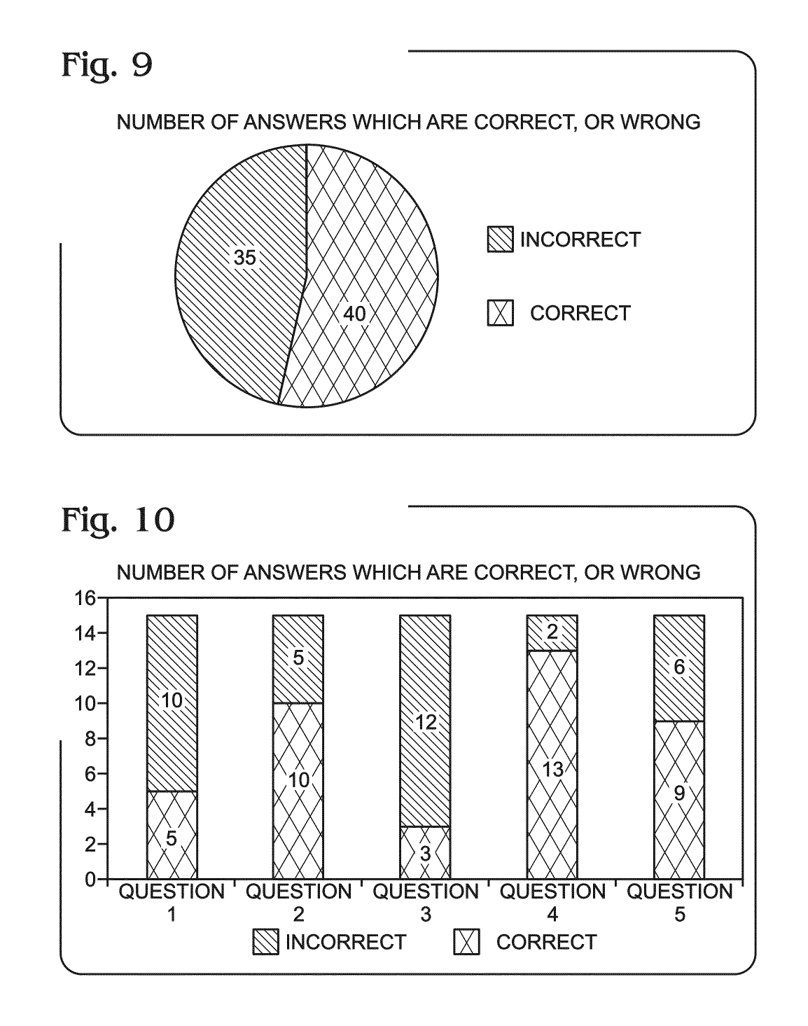

FIG. 9 is a pie chart showing counts of correct and incorrect answers to a particular test question on a classroom wide basis.

FIG. 10 is a bar chart showing counts of correct and incorrect answers to each test question “1” through “5” on a classroom wide basis.

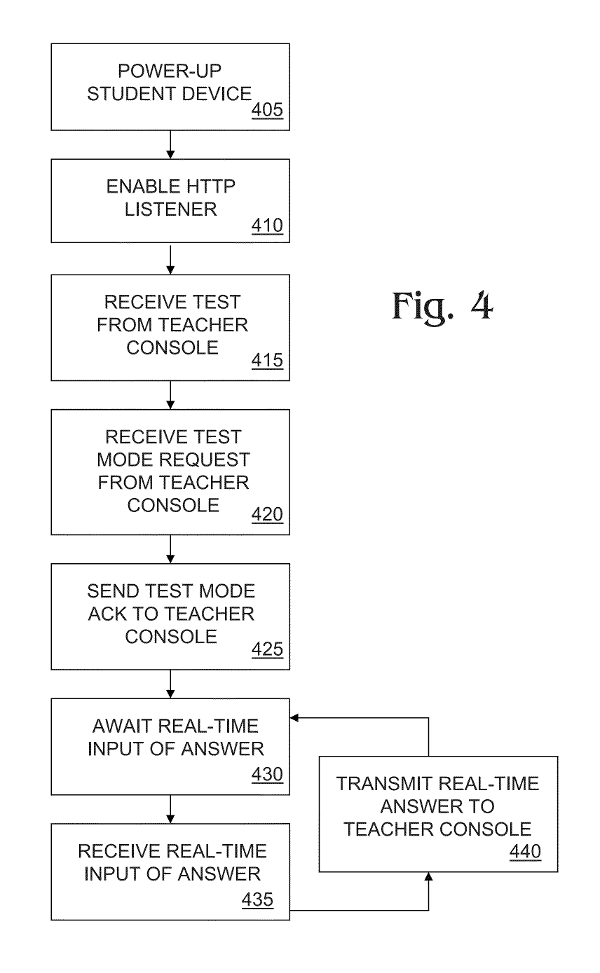

Returning now to FIG. 4, a method performed by a representative one of student devices 120A-120E for providing real-time answers to test questions on a test being administered by teacher console 110 is shown in some embodiments of the invention. This method is performed by all of student devices 120A-120E. At the outset, the student device is powered-up (405) and a Hypertext Transfer Protocol listener is enabled (410).

Next, the student device receives the test from teacher console 110 (415). An application programming interface on the student devices may be invoked by teacher console 110 allowing teacher console 110 to download the test content (e.g., test instructions, test questions, multiple choices, etc.) to the student device. Alternatively, teacher console 110 may download a web link to the student devices allowing the student device to retrieve the test content from a remote web server using a standard web browser on the student device.

Next, the student device receives a request from teacher console 110 to enter the test mode wherein the student device provides real-time answers to test questions on the test received from teacher console 110 (420). The REST protocol may be invoked for this purpose.

Next, the student device enters the test mode and transmits an acknowledgement to teacher console 110 that the student device has entered the test mode (425). The REST protocol may again be invoked.

At this point, the student device may transmit personal or background information to teacher console 110, such as the name of the student operating the student device. The student device then enters a listening state where the student device awaits input of an answer to a test question by the student who is operating the student device (430).

Next, the student device receives a real-time answer to a test question entered by the student (435). For example, where the test is a multiple choice test, the multiple choice selection “C” may be selected for question number “1”. The student device transmits in real-time the answer to teacher console 110 (440). The answer may include the question number (e.g., Question=“1”) and the multiple choice selection (e.g., Answer=“C”). The answer may also identify the student submitting the answer (e.g., “John”). Alternatively, the identity of the student submitting the answer may be inferred from the source address (e.g., IP or MAC address) of a data packet containing the answer. Once the answer is transmitted, the student device reenters the listening state where the student device awaits input of an answer by the student who is operating the student device (430).

It will be appreciated by those of ordinary skill in the art that the invention can be embodied in other specific forms without departing from the spirit or essential character hereof. The present description is thus considered in all respects to be illustrative and not restrictive. The scope of the invention is indicated by the appended claims, and all changes that come with in the meaning and range of equivalents thereof are intended to be embraced therein.

What is claimed is:

1. A teacher console for providing real-time feedback about a test being administered on a plurality of student devices, comprising:
a network interface;
a user interface; and
a processor communicatively coupled with the network interface and the user interface, wherein for each of a plurality of answers to test questions entered on the student devices the teacher console receives in real-time the answer via the network interface, under control of the processor updates in real-time, using the answer, a test-taking metric and displays in real-time on the user interface an updated test-taking chart generated using the updated test-taking metric.

2. The teacher console of claim 1, wherein the teacher console under control of the processor outputs in real-time on the user interface an alarm based at least in part on the updated test-taking metric.

3. The teacher console of claim 2, wherein the alarm is triggered based at least in part on conformance between the updated test-taking metric and an alarm condition entered on the user interface.

4. The teacher console of claim 1, wherein the teacher console transmits the test to each of the student devices via the network interface.

5. The teacher console of claim 1, wherein the teacher console transmits a web link to the test to each of the student devices via the network interface.

6. The teacher console of claim 1, wherein the teacher console transmits a test mode entry request to each of the student devices via the network interface and receives a test mode entry acknowledgement from each of the student devices via the network interface.

7. The teacher console of claim 1, wherein the updated test-taking chart displays a count of answers to a test question on a classroom wide basis.

8. The teacher console of claim 1, wherein the updated test-taking chart displays counts of answers for each of multiple choices for a test question on a classroom wide basis.

9. The teacher console of claim 1, wherein the updated test-taking chart displays counts of correct and incorrect answers to a test question on a classroom wide basis.

10. The teacher console of claim 1, wherein the updated test-taking chart displays an answer rate for a test question on a classroom wide basis.

11. The teacher console of claim 1, wherein the updated test-taking chart displays counts of correct and incorrect answers on a per student basis.

12. The teacher console of claim 1, wherein the updated test-taking chart displays an answer rate on a per student basis.

13. The teacher console of claim 1, wherein the updated test-taking chart displays a test score on a per student basis.

14. The teacher console of claim 1, wherein the updated test-taking chart is a bar chart.

15. The teacher console of claim 1, wherein the updated test-taking chart is a pie chart.

16. A student device for providing real-time answers for a test being administered by a teacher console, comprising:
a network interface;
a user interface; and
a processor communicatively coupled with the network interface and the user interface, wherein for each of a plurality of answers to test questions entered on the user interface the student device under control of the processor transmits in real-time the answer to the teacher console via the network interface whereupon the teacher console updates in real-time, using the answer, a test-taking metric and displays in real-time on the teacher console an updated test-taking chart generated using the updated test-taking metric.

17. The student device of claim 16, wherein the student device receives from the teacher console the test via the network interface.

18. The student device of claim 16, wherein the student device receives from the teacher console a web link to the test via the network interface.

19. The student device of claim 16, wherein the student device receives from the teacher console a test mode entry request via the network interface and transmits to the teacher console a test mode entry acknowledgement via the network interface.

20. A communication system for providing real-time feedback about a test being administered, comprising:
a plurality of student devices configured to receive answers to test questions entered on the student devices and transmit in real-time the answers; and
a teacher console communicatively coupled with the student devices and configured, for each answer, to receive in real-time the answer, update in real-time, using the answer, a test-taking metric and display in real-time an updated test-taking chart generated using the updated test-taking metric.
